(19) United States
(12) Patent Application Publication
(10) Pub. No.: US 2014/0340321 A1
(43) Pub. Date: Nov. 20, 2014

(54) MISTOUCH IDENTIFICATION METHOD AND DEVICE USING THE SAME

(71) Applicant: ACER INCORPORATED, New Taipei City (TW)

(72) Inventors: Yu-Min Chang, New Taipei City (TW); Hsing-Lung Chung, New Taipei City (TW)

(73) Assignee: ACER INCORPORATED, New Taipei City (TW)

(21) Appl. No.: 13/964,125

(22) Filed: Aug. 12, 2013

(30) Foreign Application Priority Data
May 14, 2013 (TW) 102117030

(51) Int. Cl. G06F 3/041

(52) U.S. Cl. CPC G06F 3/041
USPC 345/173

(57) ABSTRACT

A mistouch identification method and a device using the same are provided for an electronic device having a touch panel. The method includes obtaining a first touch and a second touch detected successively by the touch panel, and determining whether a time interval between the first touch and the second touch detected by the touch panel does not exceed a predetermined value. The method also includes determining whether the second touch constitutes an invalid area according to an appearance of the second touch when the time interval does not exceed the predetermined value. The method further includes identifying whether the first touch is a mistouch according to a degree of overlap of the first touch and the invalid area when the second touch constitutes the invalid area.

### CROSS-REFERENCE TO RELATED APPLICATION

This application claims the priority benefit of Taiwan application serial no. 102117030, filed on May 14, 2013. The entirety of the above-mentioned patent application is hereby incorporated by reference herein and made a part of this specification.

### BACKGROUND

1. Technical Field

The invention relates to an application of a touch operation. Particularly, the invention relates to a mistouch identification method of a touch panel and a device using the same.

2. Related Art

Along with development of touch control technology, input devices of a plurality of electronic products have been changed from conventional keyboards, mice or remote controllers to touch devices. For example, a mobile electronic device with a main characteristic of portability generally has a certain limitation in device volume, and by using a touch screen to serve as an input and output device, a space required by the physical keyboard is saved, which also increases the size of the screen.

When the user operates the mobile electronic device having the touch screen, the user probably mistouches the touch screen due to a device holding manner or an input pose, which results in a fact that the mobile electronic device conducts a wrong response. For example, when the user uses a tablet PC having a touch screen, and uses a stylus to draw, for the sake of input comfort, the user generally leans a side portion of the palm against the tablet PC, though the contact between the side portion of the palm and the touch screen is not a desired input actually input by the user. However, the tablet PC may draw unnecessary noise points or lines at a position corresponding to the touch operation detected by the touch screen. Predictably, the interference caused by mistouch may have a negative influence on usage experience.

### SUMMARY

Accordingly, the invention is directed to a mistouch identification method and a device using the same, which is capable of identifying a mistouch generated when a user operates an electronic device by using a stylus, so as to filter unnecessary noise points displayed on a screen and avoid enabling application programs or functions by mistake.

The invention provides a mistouch identification method, which is adapted to an electronic device having a touch panel. The method includes following steps. A first touch and a second touch detected successively by the touch panel are obtained. It is determined whether a time interval between the first and the second touches detected by the touch panel does not exceed a predetermined value. It is determined whether the second touch constitutes an invalid area according to an appearance of the second touch when the time interval does not exceed the predetermined value. It is identified whether the first touch is a mistouch according to a degree of overlap of the first touch and the invalid area when the second touch constitutes the invalid area.

The invention provides a mistouch identification device, which is adapted to an electronic device having a touch panel. The mistouch identification device includes a touch obtaining module, a time interval determination module, an invalid area determination module and a mistouch identification processing module. The touch obtaining module obtains a first touch and a second touch detected successively by the touch panel. The time interval determination module determines whether a time interval between the first and the second touches detected by the touch panel does not exceed a predetermined value. The invalid area determination module determines whether the second touch constitutes an invalid area according to an appearance of the second touch when the time interval determination module determines that the time interval does not exceed the predetermined value. The mistouch identification processing module identifies whether the first touch is a mistouch according to a degree of overlap of the first touch and the invalid area when the invalid area determination module determines that the second touch constitutes the invalid area.

According to the above descriptions, the mistouch identification method and the device using the same can effectively identify the mistouch generated when the user uses the stylus to operate on the electronic device, so as to eliminate the noise points displayed on the screen due to the mistouch, and avoid enabling unnecessary functions or application programs by mistake.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of an electronic device according to an embodiment of the invention.

FIG. 2 is a block diagram of a mistouch identification device according to an embodiment of the invention.

FIG. 3 is a flowchart illustrating a mistouch identification method according to an embodiment of the invention.

FIG. 4A and FIG. 4B are schematic diagrams respectively illustrating relative positions of a touch and a valid area according to an embodiment of the invention.

FIG. 5 is a flowchart illustrating a mistouch identification method according to another embodiment of the invention.

FIG. 6A is a schematic diagram of a layout of an operating interface of a multimedia player program according to an embodiment of the invention.

FIG. 6B is a schematic diagram of a layout of an operating interface of a file editing program according to an embodiment of the invention.

### DETAILED DESCRIPTION OF DISCLOSED EMBODIMENTS

When a user uses a stylus to perform an input operation on a touch panel, a contact area between user's hand (for example, the palm or a side portion thereof) and the touch panel is regarded as an invalid area, i.e. the system does not react in response to a touch operation in the invalid area. However, since there is a time interval between detection of a first touch and determination of constituting a palm area (the invalid area), before the palm area is constituted, the first detected touch is regarded as a valid input to display corresponding content on a screen or generate a corresponding trigger event. The invention provides a mistouch identification method and a device using the same, which may effectively identify a mistouch and decrease probability of wrong operation of the electronic device.

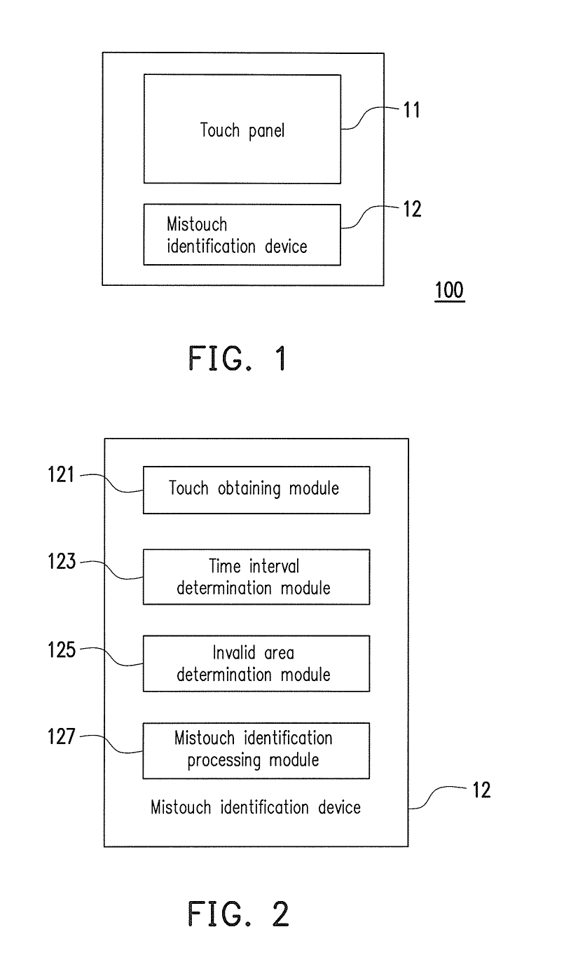

FIG. 1 is a schematic diagram of an electronic device according to an embodiment of the invention. Referring to FIG. 1, the electronic device 100 of the present embodiment is, for example, a mobile phone, a smart phone, a personal digital assistant, a tablet PC, a game machine or an E-book, which is not limited by the invention. The electronic device 100 includes a touch panel 11 and a mistouch identification device 12.

The touch panel 11 is, for example, a resistive touch panel, a capacitive touch panel or a touch panel composed of other types of touch sensing devices. The touch panel 11 corresponds a display area of a screen (not shown) of the electronic device 100, and the touch panel 11 receives a touch operation and the screen displays a corresponding frame. In an embodiment, the touch panel 11 and the screen are in a same module (i.e. the touch panel 11 and the screen construct a touch screen), and a size of the touch panel 11 matches a size of a display area. In another embodiment, the touch panel 11 and the screen are two independent modules, and the size of the touch panel 11 can be the same or different to the size of the display area.

The mistouch identification device 12 is, for example, a software or hardware device configured in the electronic device 100, which is used for determining whether a touch operation received by the touch panel 11 is a valid operation preformed by the user or simply a mistouch.

Modules in the mistouch identification device 12 and functions of the modules are described with reference of FIG. 2. The mistouch identification device 12 includes a touch obtaining module 121, a time interval determination module 123, an invalid area determination module 125 and a mistouch identification processing module 127. The aforementioned modules are, for example, hardware devices composed of logic circuit components, and execute a function of identifying the mistouch on the touch panel, or the aforementioned modules can be programs stored in a storage medium of the electronic device 100, which can be loaded into a processor of the electronic device 100 to execute the function of identifying the mistouch on the touch panel, which is not limited by the invention.

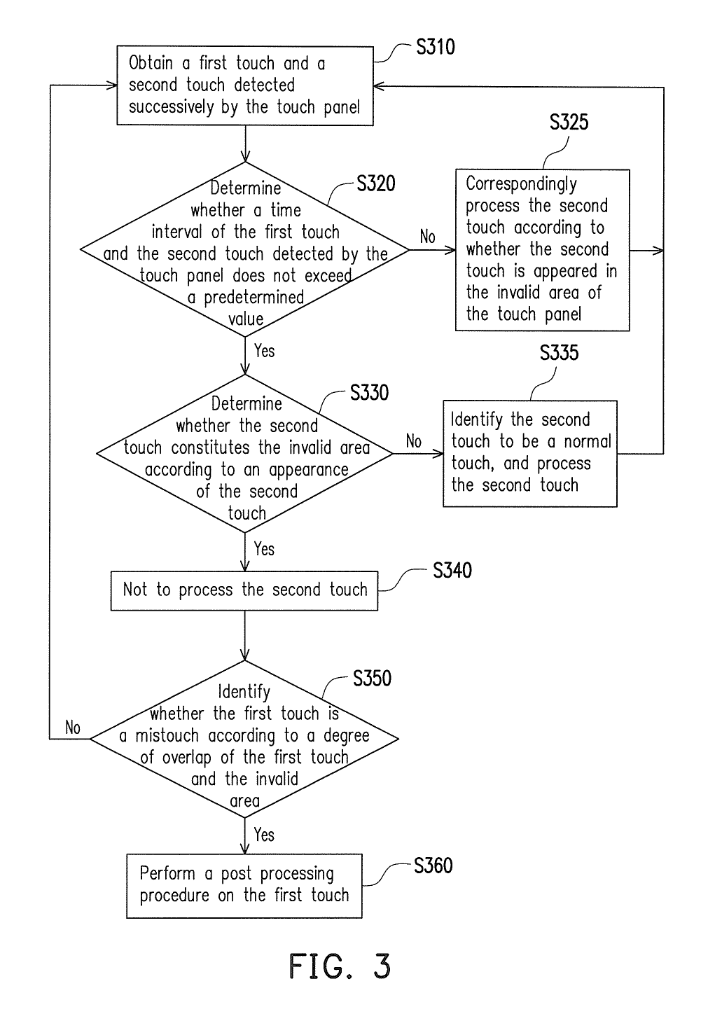

FIG. 3 is a flowchart illustrating a mistouch identification method according to an embodiment of the invention. Referring to FIG. 1 and FIG. 3, the mistouch identification method of the present embodiment is adapted to the above mistouch identification device 12, and detailed steps of the mistouch identification method of the present embodiment are described below with reference of various component of the mistouch identification device 12.

In step S310, the touch obtaining module 121 obtains a first touch and a second touch detected successively by the touch panel 11. It should be noticed that the touch panel 11 does not detect other touch during the period of detecting the first touch and the second touch. In other words, each time when the touch panel 11 detects a current touch (i.e. the second touch), the touch obtaining module 121 of the present embodiment obtains a previous touch detected by the touch panel 11 to serve as the first touch. Since the touch panel 11 continually detects touches and the electronic device 100 performs corresponding processing according to the touches detected by the touch panel 11, when the touch panel 11 detects the second touch, the electronic device 100 have performed corresponding processing on the first touch detected by the touch panel 11 (for example, have drawn corresponding input points according to the touch on the display area of the screen, or have generated a corresponding trigger event according to a touch position, etc.). The mistouch identification device 12 of the present embodiment mainly identifies whether the first touch is a mistouch according to following steps, so as to determine whether a post processing procedure is required on the processed first touch.

Then, in step S320, the time interval determination module 123 determines whether a time interval between the first touch and the second touch detected by the touch panel 11 does not exceed a predetermined value. The predetermined value is, for example, 0.1 second, though the invention is not limited thereto.

If a determination result of the step S320 is negative, it represents that a relevance between the first touch and the second touch is relatively low, and the second touch can be regarded as an independent touch input, and in step S325, the mistouch identification processing module 127 identifies whether the second touch is a mistouch and performs a corresponding processing according to whether the second touch is appeared in the invalid area of the touch panel 11. In an embodiment, if the second touch is appeared in the invalid area, the touch identification processing module 127 identifies the second touch to be the mistouch, and notifies the electronic device 100 not to process the second touch. If the second touch is outside the invalid area, the touch identification processing module 127 identifies the second touch to be a normal touch, and notifies the electronic device 100 to process the second touch. In another embodiment, if the touch panel 11 does not have any invalid area, the touch identification processing module 127 identifies the second touch to be a normal touch, and notifies the electronic device 100 to process the second touch. Then, the flow of the mistouch identification method of the present embodiment returns to the step S310, and the touch obtaining module 121 re-obtains the first touch and the second touch to implement follow-up steps.

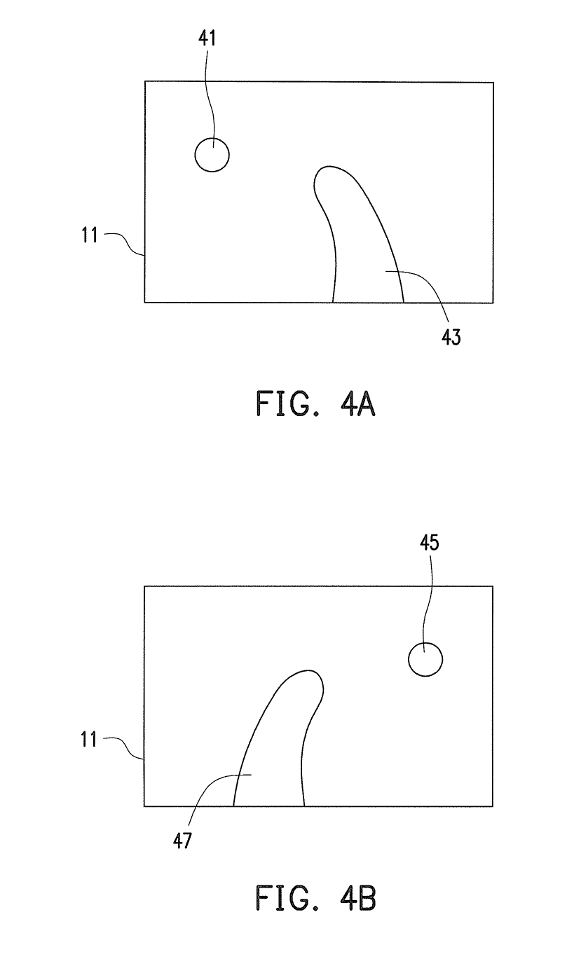

When the time interval determination module 123 determines that the time interval does not exceed the predetermined value (i.e. the determination result of the step S320 is affirmative), in step S330, the invalid area determination module 125 determines whether the second touch constitutes the invalid area according to an appearance of the second touch. In detail, the invalid area determination module 125 determines whether the second touch constitutes the invalid area according to a total area and/or a shape of the second touch. For example, when the total area of the second touch is greater than an area threshold, the second touch is probably an input caused by the palm, so that the invalid area determination module 125 determines that the second touch constitutes the invalid area. Alternatively, when the shape of the second touch is not conformed to a predetermined shape (for example, regular shapes liable to be generated by the stylus input such as a round or a near round, etc.), the invalid area determination module 125 determines that the second touch constitutes the invalid area. Further, the invalid area determination module 125 determines that the second touch constitutes the invalid area when the total area of the second touch is greater than the area threshold and the shape of the second touch is not conformed to the predetermined shape. In another embodiment, the user can change a dominant hand operation setting of the electronic device 100 according to a dominant hand. Generally, when the dominant hand of the user is the right hand, the area where the palm contacts the touch panel 11 is appeared to the right of the area where the stylus contacts the touch panel 11, so that the invalid area of the touch panel 11 has a higher chance to appear to the right of a valid area. Comparatively, when the dominant hand of the user is the left hand, the area where the palm contacts the touch panel 11 is appeared to the left of the area where the stylus contacts the touch panel 11, so that the invalid area of the touch panel 11 has a higher chance to appear to the left of the valid area. In this way, the invalid area determination module 125 further determines whether a relative position between the valid area and the second touch on the touch panel 11 corresponds to the dominant hand operation setting when the total area of the second touch is greater than the area threshold and/or the shape of the second touch is not conformed to the predetermined shape, and determines that the second touch constitutes the invalid area when the relative position corresponds to the dominant hand operation setting. It is assumed that the dominant hand operation setting of the electronic device 100 is the right hand, referring to FIG. 4A, since the second touch (represented by a contact area 43) is appeared on the touch panel 11 to the right of the assured valid area 41, the invalid area determination module 125 determines that the second touch constitutes the invalid area. It is assumed that the dominant hand operation setting of the electronic device 100 is the left hand, referring to FIG. 4B, since the second touch (represented by a contact area 47) is appeared on the touch panel 11 to the left of the assured valid area 45, the invalid area determination module 125 determines that the second touch constitutes the invalid area.

When the invalid area determination module 125 determines that the second touch does not constitute the invalid area. In step S335, the touch identification processing module 127 identifies the second touch to be a normal touch, and notifies the electronic device 100 to process the second touch. Then, the flow of the mistouch identification method of the present embodiment returns to the step S310, and the touch obtaining module 121 re-obtains the first touch and the second touch to implement follow-up steps.

When the invalid area determination module 125 determines that the second touch constitutes the invalid area, touches appeared in the invalid area are all filtered, so that in step S340, the touch identification processing module 127 notifies the electronic device 100 not to process the second touch.

Then, in step S350, the mistouch identification processing module 127 identifies whether the first touch is a mistouch according to a degree of overlap of the first touch and the invalid area. In detail, the mistouch identification processing module 127 identifies the first touch to be the mistouch when an area of the overlapped part of the first touch that is overlapped to the invalid area reaches a specific proportion of a total area of the first touch. It is assumed that the specific proportion is 100%, when the first touch is completely located within the invalid area, the mistouch identification processing module 127 identifies the first touch to be the mistouch. It is assumed that the specific proportion is 90%, when 90% of the first touch is located within the invalid area, the mistouch identification processing module 127 identifies the first touch to be the mistouch. The aforementioned specific proportions are only examples, and the invention is not limited thereto.

If the determination result of the step S350 is negative, the flow of the mistouch identification method of the present embodiment returns to the step S310, and the touch obtaining module 121 re-obtains the first touch and the second touch to implement follow-up steps.

If the determination result of the step S350 is affirmative, in step S360, the mistouch identification processing module 127 performs a post processing procedure on the first touch. For example, the mistouch identification processing module 127 eliminates the content displayed in the display area of the screen of the electronic device 100 in response to the first touch when the first touch is identified to be the mistouch. Moreover, the mistouch identification processing module 127 cancels the trigger event generated in response to the first touch when the first touch is identified to be the mistouch, and the trigger event can be an application program enabling event or a key selecting event, etc.

As shown in FIG. 3, not only the electronic device 100 purely avoids processing the touch occurred in the invalid area after determining the invalid area, but it is also further identified whether a processed touch is the mistouch, and a post processing procedure is performed in case that the processed touch is the mistouch, so as to avoid drawing noise points on the screen due to the mistouch or enabling unnecessary functions or application programs.

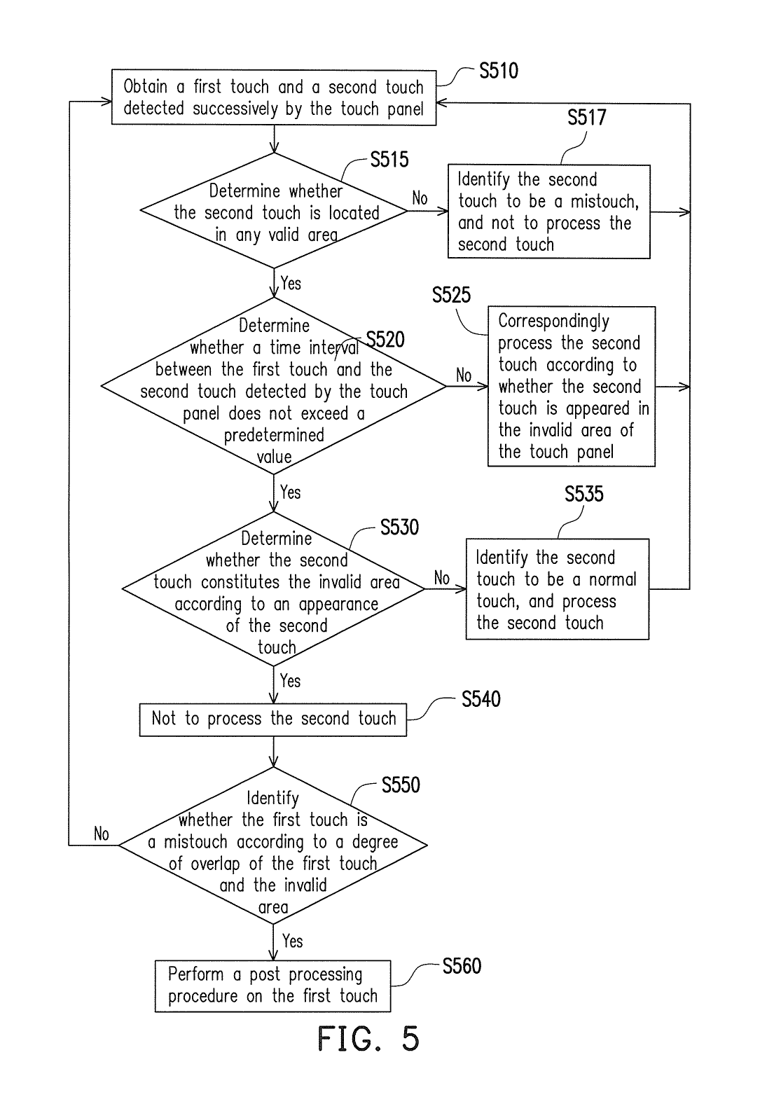

FIG. 5 is a flowchart illustrating a mistouch identification method according to another embodiment of the invention. In the present embodiment, the mistouch identification device 12 can determine at least one valid area on the touch panel 11 according to a usage state of the electronic device 100 and/or an operating behavior historical record of the electronic device 100, where the usage state corresponds to a type of an application program executed on the electronic device 100 and/or a type of a file opened on the electronic device 100. Only when the current touch detected by the touch panel 11 is occurred in the valid area, the mistouch identification device 12 further determines whether to perform the post processing procedure on the touch previously detected by the touch panel 11.

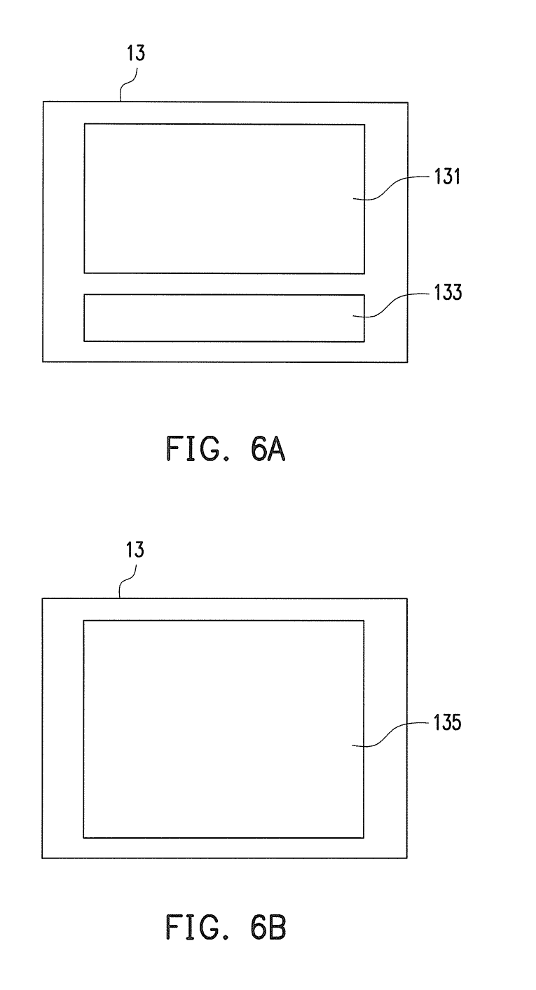

In detail, since different application programs may provide different operating interfaces, areas capable of receiving the user's input are different. Taking FIG. 6A as an example, it is assumed that the application program executed on the electronic device 100 is a multimedia player program, and the operating interface of the multimedia player program divides a display area 13 of the screen of the electronic device 100 into a playing area 131 and a toolbar area 133, where the playing area 131 with a larger range is used to display content of a multimedia file, and the toolbar area 133 with a smaller range is used to display various options of tools used for operating the multimedia file. The time interval determination module 123 defines an area corresponding to the toolbar area 133 in the touch panel 11 as the valid area according to a corresponding relationship of the touch panel 11 and the display area 13, and defines an area corresponding to the playing area 131 in the touch panel 11 as the invalid area. Moreover, in the example shown in FIG. 6B, it is assumed that the application program executed on the electronic device 100 is a file editing program, the operating interface thereof plans most of the display area 13 of the screen of the electronic device 100 as an editing area 135 suitable for receiving input, and the time interval determination module 123 defines an area corresponding to the editing area 135 in the touch panel 11 as the valid area according to a corresponding relationship of the touch panel 11 and the display area 13, and defines other area as the invalid area. Alternatively, the time interval determination module 123 can also neglect the layout of the operating interface of the currently executed application program, and define the touch panel 11 as the valid area or the invalid area only according to the type of the application program. For example, when the application program executed on the electronic device 100 is the file editing program, the whole touch panel 11 is defined as the valid area.

Besides, since the user has different usage habits for different types of files, the time interval determination module 123 can also define the valid area of the touch panel 11 according to the type of the file opened on the electronic device 100. For example, after a video, a music or a photo is opened, it is generally browsed by the user only, so that when the file opened on the electronic device 100 is a multimedia file, the time interval determination module 123 defines a major part of the touch panel 11 as the invalid area, and defines a minor part of the touch panel 11 as the valid area. When the file opened on the electronic device 100 is a text, a spreadsheet or a slide, etc. that requires extensive edition, the time interval determination module 123 defines a major part of the touch panel 11 as the valid area, and defines a minor part of the touch panel 11 as the invalid area.

It is assumed that a storage unit of the electronic device 100 stores an operating behavior historical record, which records usage habits of the user using various application programs, for example, areas where input operations are constantly performed after the application program is opened. After the time interval determination module 123 learns the application program executed on the electronic device 100, the time interval determination module 123 obtains the area where input operations are constantly performed according to the operating behavior historical record, and defines the area as the valid area of the touch panel 11.

In the embodiment of FIG. 5, after the touch obtaining module 121 obtains the first touch and the second touch (step S510), the time interval determination module 123 determines whether the second touch is located in any valid area (step S515). If the second touch is not located in the valid area, the touch identification processing module 127 identifies the second touch to be a mistouch, and notifies the electronic device 100 not to process the second touch (step S517). Then, the flow of the mistouch identification method of the present embodiment returns to the step S510, and the touch obtaining module 121 re-obtains the first touch and the second touch to implement follow-up steps.

If the second touch is located in the valid area, the time interval determination module 123 determines whether a time interval between the first touch and the second touch detected by the touch panel 11 does not exceed a predetermined value (step S520). The steps S520 to S560 of FIG. 5 are similar to the steps S320 to S360 of FIG. 3, which are not repeated.

In summary, the mistouch identification method and the device using the same can effectively determine the points required to be erased, so as to avoid wrong operations executed by the electronic device, and accordingly increase operation accuracy of the electronic device, and the user may have a better operating experience when operating the electronic device.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A mistouch identification method, adapted to an electronic device having a touch panel, the method comprising:
obtaining a first touch and a second touch detected successively by the touch panel;
determining whether a time interval between the first touch and the second touch detected by the touch panel does not exceed a predetermined value;
determining whether the second touch constitutes an invalid area according to an appearance of the second touch when the time interval does not exceed the predetermined value; and
identifying whether the first touch is a mistouch according to a degree of overlap of the first touch and the invalid area when the second touch constitutes the invalid area.

2. The method as claimed in claim 1, further comprising:
determining at least one valid area on the touch panel according to a usage state and/or an operating behavior historical record of the electronic device; and
executing the step of determining whether the time interval between the first touch and the second touch does not exceed the predetermined value only when the second touch is located in one of the at least one valid area.

3. The method as claimed in claim 1, wherein the step of identifying whether the first touch is the mistouch according to the degree of overlap of the first touch and the invalid area when the second touch constitutes the invalid area comprises:
identifying the first touch to be the mistouch when an area of an overlapped part of the first touch that is overlapped to the invalid area reaches a specific proportion of a total area of the first touch.

4. The method as claimed in claim 1, wherein the touch panel corresponds to a display area of a screen of the electronic device, and after the step of identifying whether the first touch is the mistouch according to the degree of overlap of the first touch and the invalid area, the mistouch identification method further comprises:
eliminating content displayed in the display area in response to the first touch or cancelling a trigger event generated in response to the first touch when the first touch is identified to be the mistouch.

5. The method as claimed in claim 1, wherein the step of determining whether the second touch constitutes the invalid area according to the appearance of the second touch comprises:
determining whether a relative position of a valid area on the touch panel and the second touch corresponds to a dominant hand operation setting when a total area of the second touch is greater than an area threshold and/or a shape of the second touch is not conformed to a predetermined shape; and
determining that the second touch constitutes the invalid area when the relative position corresponds to the dominant hand operation setting.

6. A mistouch identification device, adapted to an electronic device having a touch panel, comprising:
a touch obtaining module, obtaining a first touch and a second touch detected successively by the touch panel of the electronic device;
a time interval determination module, determining whether a time interval between the first touch and the second touch detected by the touch panel does not exceed a predetermined value;
an invalid area determination module, determining whether the second touch constitutes an invalid area according to an appearance of the second touch when the time interval determination module determines that the time interval does not exceed the predetermined value; and
a mistouch identification processing module, identifying whether the first touch is a mistouch according to a degree of overlap of the first touch and the invalid area when the invalid area determination module determines that the second touch constitutes the invalid area.

7. The mistouch identification device as claimed in claim 6, wherein the time interval determination module determines at least one valid area on the touch panel according to a usage state and/or an operating behavior historical record of the electronic device, and determines whether the time interval between the first touch and the second touch does not exceed the predetermined value only when the second touch is located in one of the at least one valid area.

8. The mistouch identification device as claimed in claim 6, wherein the mistouch identification processing module identifies the first touch to be the mistouch when an area of an overlapped part of the first touch that is overlapped to the invalid area reaches a specific proportion of a total area of the first touch.

9. The mistouch identification device as claimed in claim 6, wherein the touch panel corresponds to a display area of a screen of the electronic device, and the mistouch identification processing module eliminates content displayed in the display area in response to the first touch or cancels a trigger event generated in response to the first touch when the first touch is identified to be the mistouch.

10. The mistouch identification device as claimed in claim 6, wherein the invalid area determination module determines whether a relative position of a valid area on the touch panel and the second touch corresponds to a dominant hand operation setting when a total area of the second touch is greater than an area threshold and/or a shape of the second touch is not conformed to a predetermined shape, and determines that the second touch constitutes the invalid area when the relative position corresponds to the dominant hand operation setting.
